(19) United States
(12) Patent Application Publication
(10) Pub. No.: US 2024/0241505 A1
(43) Pub. Date: Jul. 18, 2024

(54) SYSTEM AND METHOD FOR APPLYING A PRIORI INSPECTION TO PRIORITIZE CORES FOR RE* OPERATIONS

(71) Applicant: Hitachi, Ltd., Tokyo (JP)

(72) Inventors: Manish GUPTA, Sunnyvale, CA (US); Dipanjan GHOSH, Santa Clara, CA (US); Umeshwar DAYAL, Saratoga, CA (US); Anastasia OSLING, Grass Valley, CA (US)

(21) Appl. No.: 18/156,297

(22) Filed: Jan. 18, 2023

(51) Int. Cl. G05B 23/02; G06Q 30/0283

(52) U.S. Cl. CPC G05B 23/0224; G06Q 30/0283; G05B 2223/02

(57) ABSTRACT

A method for core remanufacturing evaluation. The method may include acquiring available core data for a selected core from a plurality of cores; analyzing the available core data related to the selected core to assess an internal condition of the selected core and identify faults; identifying, based on the internal condition and the identified faults, part and processes needed to remanufacture the core; deriving metrics for part and processes needed to remanufacture the core; computing, from the derived metrics, a utility measure representing an estimate of potential value generated or potential impact generated if the core is remanufactured; determining a remanufacturing priority based on the computed utility measure; and performing remanufacturing of the selected core based on the determined remanufacturing priority.

### BACKGROUND

### Field

The present disclosure is generally directed to a method and a system for core remanufacturing evaluation, and more specifically, to a method of core evaluation through utility measurement to estimate values or impact of remanufacturing.

### Related Art

Megatrends such as population growth, urbanization, climate change, resource scarcity, and resource price volatility are making the transition from Linear Economy to Circular Economy (CE) inevitable. CE is a move towards an economic system that prioritizes environment and society while providing economic value. Aside from delivering the disruptive changes needed for a sustainable future, CE is creating new opportunities for businesses to enter new markets with innovative products and services, and clearing the path to long-term growth.

FIG. 1 illustrates a conventional CE model. As illustrated in FIG. 1, five critical CE business models form the CE model, specifically, circular inputs, sharing platforms, servitization, resource recovery, and product-life extension. Product-life extension is focused on keeping products and materials in use for as long as possible through various value-retention or Re* processes (e.g., Remanufacturing, Refurbishment, Repair, Reuse). Resource Recovery is focused on recovering material and energy embedded in products that have reached end-of-life. The two models are complementary and essential to cover entire product lifecycle. The two business models are also key to establishing a closed-loop value chain, which is one of the primary objectives of CE, and may be referred to as asset recovery.

Amongst the various value-retention processes that constitute asset recovery and Re*, remanufacturing, is considered as the ultimate form of recycling. While the process may consume additional resources (material, energy, labor), it also provides a full new service life to used products. Upcycling is a key part of remanufacturing as often upgrades are applied during the remanufacturing process. Remanufacturing provides immense economic, environmental, and social benefits.

Despite the immense CE benefits, the prevalence of remanufacturing is limited and is estimated to be about ˜2% of new manufacturing. Remanufacturing is very different from new manufacturing and remanufacturers face many challenges. Many of the challenges of remanufacturing stem from the variable nature of inputs associated with the process. The key input materials for remanufacturing are used products and components (called “Cores”), which are to be collected from multitude of users and typically have different degrees of wear-and-tear. This introduces many challenges in “core management” phase, which has significant downstream impact on inventory and production planning.

In the related art, enterprise resource planning (ERP) solutions have been adopted by the manufacturing industry for remanufacturing. However, this approach fails to distinguish the various challenges presented by remanufacturing when contrasted from manufacturing. Consequently, remanufacturers struggle with applying ERP solutions in the remanufacturing setting and address the challenges associated with the process.

In the related art, point-solutions are utilized to address parts of the recovery operations. These solutions focus primarily on workflows management as opposed to optimization. While Internet of Things (IOT) tracking/monitoring solutions are utilized in a number of sectors and industries, such solutions are not yet prevalent in the remanufacturing industry.

### SUMMARY

Aspects of the present disclosure involve an innovative method for core remanufacturing evaluation. The method may include acquiring available core data for a selected core from a plurality of cores; analyzing the available core data related to the selected core to assess an internal condition of the selected core and identify faults; identifying, based on the internal condition and the identified faults, part and processes needed to remanufacture the core; deriving metrics for part and processes needed to remanufacture the core; computing, from the derived metrics, a utility measure representing an estimate of potential value generated or potential impact generated if the core is remanufactured; determining a remanufacturing priority based on the computed utility measure; and performing remanufacturing of the selected core based on the determined remanufacturing priority.

Aspects of the present disclosure involve an innovative non-transitory computer readable medium, storing instructions for core remanufacturing evaluation. The instructions may include acquiring available core data for a selected core from a plurality of cores; analyzing the available core data related to the selected core to assess an internal condition of the selected core and identify faults; identifying, based on the internal condition and the identified faults, part and processes needed to remanufacture the core; deriving metrics for part and processes needed to remanufacture the core; computing, from the derived metrics, a utility measure representing an estimate of potential value generated or potential impact generated if the core is remanufactured; determining a remanufacturing priority based on the computed utility measure; and performing remanufacturing of the selected core based on the determined remanufacturing priority.

Aspects of the present disclosure involve an innovative server system for core remanufacturing evaluation. The server system may include acquiring available core data for a selected core from a plurality of cores; analyzing the available core data related to the selected core to assess an internal condition of the selected core and identify faults; identifying, based on the internal condition and the identified faults, part and processes needed to remanufacture the core; deriving metrics for part and processes needed to remanufacture the core; computing, from the derived metrics, a utility measure representing an estimate of potential value generated or potential impact generated if the core is remanufactured; determining a remanufacturing priority based on the computed utility measure; and performing remanufacturing of the selected core based on the determined remanufacturing priority.

Aspects of the present disclosure involve an innovative system for core remanufacturing evaluation. The method may include means for acquiring available core data for a selected core from a plurality of cores; means for analyzing the available core data related to the selected core to assess an internal condition of the selected core and identify faults; means for identifying, based on the internal condition and the identified faults, part and processes needed to remanufacture the core; means for deriving metrics for part and processes needed to remanufacture the core; means for computing, from the derived metrics, a utility measure representing an estimate of potential value generated or potential impact generated if the core is remanufactured; means for determining a remanufacturing priority based on the computed utility measure; and means for performing remanufacturing of the selected core based on the determined remanufacturing priority.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates a conventional CE model.

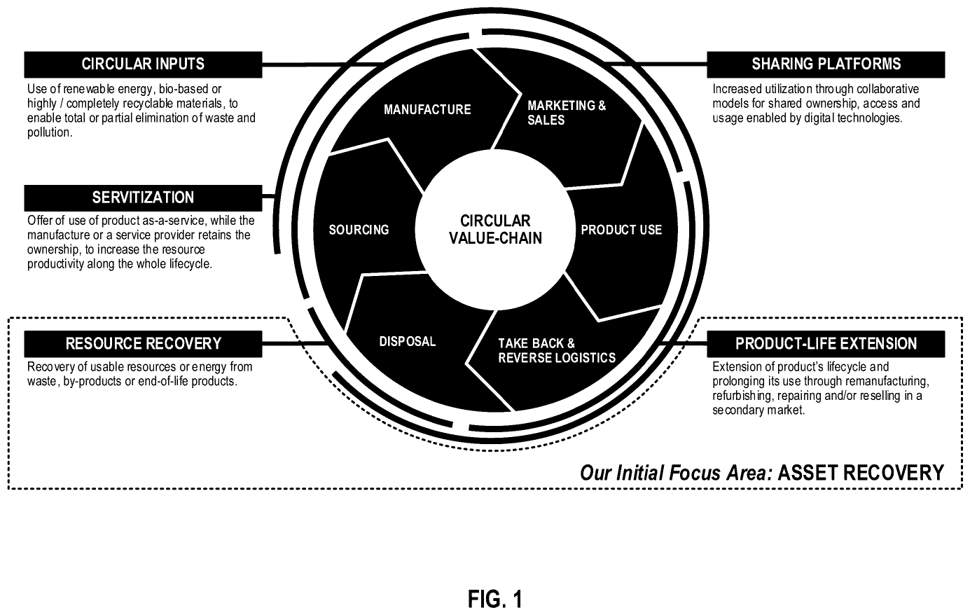

FIG. 2 illustrates an example partial process flow of a conventional remanufacturing process.

FIG. 3 illustrates an example process flow for core evaluation in a remanufacturing process, in accordance with an example implementation.

FIG. 4 illustrates an example data flow of a partial remanufacturing process that utilizes the core condition assessment and valuation process, in accordance with an example implementation.

FIG. 5 illustrates an example flow process for building a machine learning model, in accordance with an example implementation.

FIG. 6 illustrates an example pump driven by a motor, in accordance with an example implementation.

FIG. 7 illustrates an example SOP table generated using analyzed past remanufacturing data, in accordance with an example implementation.

FIG. 8 illustrates an example process flow to derive remediation needs to remanufacture a core, in accordance with an example implementation.

FIG. 9 illustrates an example computation process of embedded energy and emissions, in accordance with an example implementation.

FIG. 10 illustrates an example display for viewing, uploading, and analyzing the operational data using the core condition assessment and validation process, in accordance with an example implementation.

FIG. 11 illustrates an example screen for viewing, uploading, and analyzing the sensor/IoT data using the core condition assessment and validation process, in accordance with an example implementation.

FIG. 12 illustrates an example screen for viewing, uploading, and analyzing the tests and measurements data using the core condition assessment and validation process, in accordance with an example implementation.

FIG. 13 illustrates an example inspection summary page, in accordance with an example implementation.

FIG. 14 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

The primary input materials for remanufacturing are used products and components (called “cores”). Core acquisition is the most challenging part of a remanufacturing operation, as remanufacturers struggle with uncertainties surrounding acquired cores. These uncertainties relate largely to uncertainty associated with return timing and quantities, and uncertainty in quality of returned cores. To address the uncertainties, the typical approach applied by remanufacturers is overstocking of cores. Overstocking ties up working capital and leads to excess and obsolete inventory in the longer run.

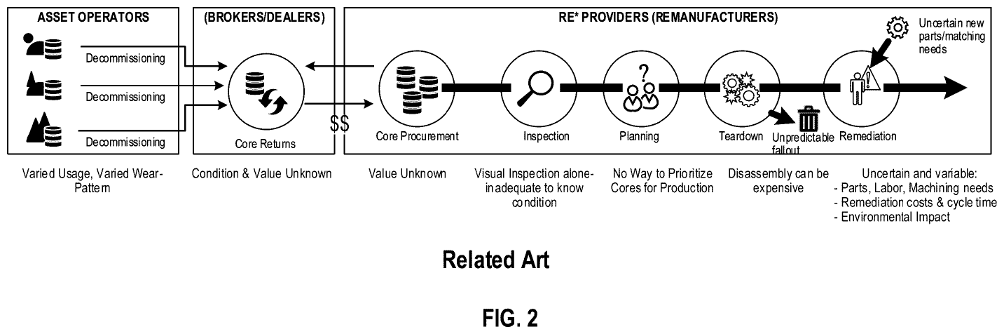

FIG. 2 illustrates an example partial process flow of a conventional remanufacturing process. An asset/product is purchased and used by an asset operator. Usage scenarios of identical units of a product may vary drastically in the field from one asset operator to another. For instance, units may be deployed in different geographic locations, operated under different conditions, for different applications, under different load patterns, for different lengths of time, operated by different users, maintained differently, etc. Such variations lead to different degrees of wear-and-tear. Consequently, used products that are returned as cores have different levels of quality and condition of internal parts.

At the late-lifecycle of an aging product, the product is decommissioned and delivered to brokers/dealers for trade with Re* providers. While the product is in the possession of the broker, the condition and value of the product remain unknown and undiscoverable without performing a thorough inspection on the product, which is often cost prohibitive. Actual product inspection may be performed after the Re* provider has procured the core.

Currently, only visual inspection is done on cores, which is inadequate to assess the condition of inner parts. The real condition is known only when the core is torn down or disassembled, cleaned, and inspected. These could be time-consuming and resource-intensive operations, particularly for complex industrial equipment. For instance, a large diesel engine may require labor hours that exceed ten hours for disassembly alone. Variability in core quality leads to variability in material recovery (or conversely in fall-out), which in turn induces variability in production planning and resource needs (i.e., the parts, processing, and labor needs vary significantly from one core to another). This ultimately results in variability in cycle time, yield, and remanufacturing costs. A side-effect of uncertainty is the need to overstock cores, as multiple cores may be needed to produce a single unit of remanufactured product if fall-out is high. If there are not enough cores available, then either demand fulfillment is delayed or new parts may need to be used which can substantially increase the costs of remanufacturing.

Remanufacturers and Re* providers struggle with prioritizing cores for production as they do not know the internal condition of the cores and potential fallouts. A core's real condition is often revealed after performing teardown/disassembly, cleaning, and inspection, which are often expensive operations in terms of required labor and resource.

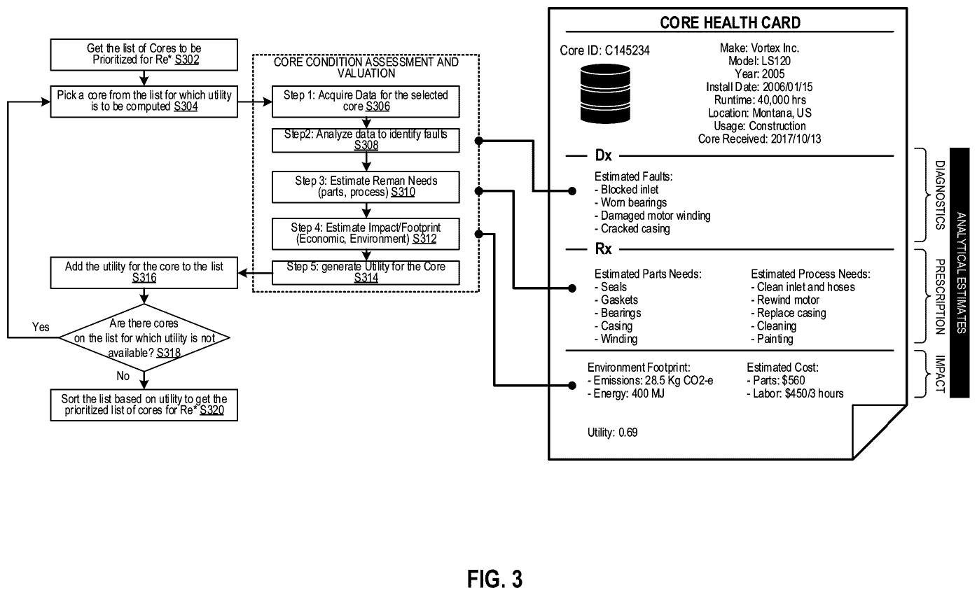

FIG. 3 illustrates an example process flow for core evaluation in a remanufacturing process, in accordance with an example implementation. The process provides estimates of fallouts and environmental impact of remanufacturing a particular core prior to performing a teardown of the core. Such estimates can be used to compare and rank the cores based on the value they can generate. The process begins at S302, where a list of cores to be prioritized for Re* is received. At S304, a core is selected from the list for utility computation. Specifically, a core condition assessment and valuation process is performed on the selected core. For a core to be evaluated, the core condition assessment and valuation process provides a utility which can be used to compare it with utilities of other cores. In addition, the process enables generation of a “core health card,” which summarizes the predictions of faults in the cores (i.e., diagnostics), forecast for parts and processes needed to fix those faults (i.e., prescription), estimates of environment and cost metrics associated with the fixes (i.e., impact), and a utility measure indicating value that remanufacturing the core provides.

As illustrated in FIG. 3, there are five steps to the core condition assessment and valuation process. First, data associated with the selected core is acquired at S306. Data is the most crucial component for a priori assessment of cores. Typically, the more volume and fidelity of available data, the better the assessment can be. Multiple value-chain participants may own or touch an asset during the asset's ownership, and hence the data may not be available from a single entity. Hence, aggregation across the value-chain participants may be required.

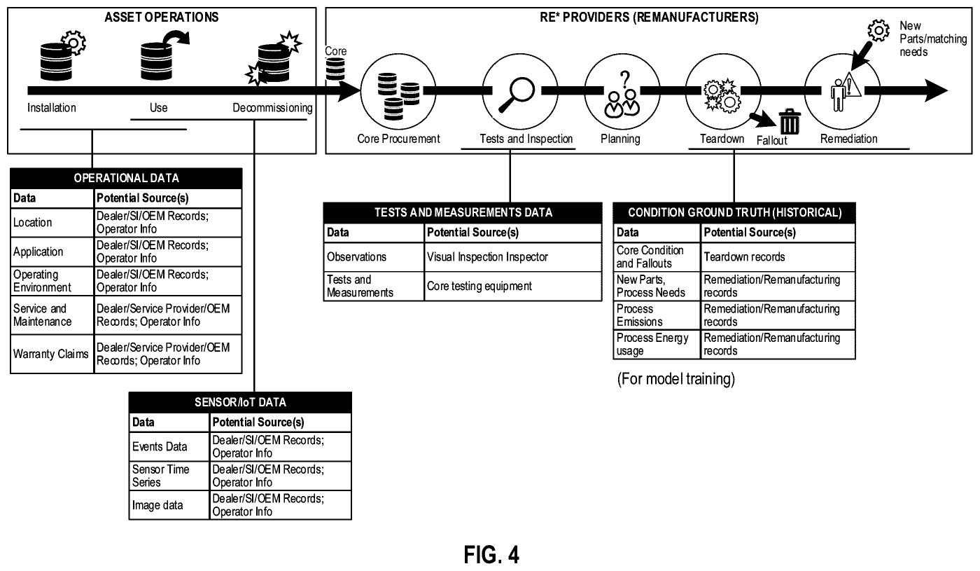

Data can be broadly categorized into three categories based on an asset's remanufacturing lifecycle. FIG. 4 illustrates an example data flow of a partial remanufacturing process that utilizes the core condition assessment and valuation process, in accordance with an example implementation. As illustrated in FIG. 4, data is categorized into the categories of operational data, sensor/IoT data, and tests and measurements data.

Operational data comprises usage related data that captures macro patterns associated with a core. This includes data such as, but not limited to, location of operation, application, operating environment, service and maintenance records, warranty claims, etc. Operational data may be captured and recorded by entities such as asset operator, original equipment manufacturers (OEMs), manufacturers of equipment, dealers, service providers, system integrators, etc. In addition, the equipment owners and operators have access to such information. Operational data may be tracked between an asset's installation and during actual use.

Sensor/IoT data comprises event data that captures occurrences of events. This includes data such as, but not limited to, an outage, breach of threshold or of operational parameters, etc. Captured data may be in the form of time-series data, wherein sensor readings are collected at predetermined or adjustable intervals. Sensors may include, but not limited to, those that can measure temperature, pressure, vibration, flow, speed, force, etc. Sensor/IoT data can also include image data, for example pictures of parts/components or images taken using thermal imaging devices. Sensor data that may be collected or is relevant for analyses of cores' condition may include data captured over a long period, in short bursts, or in response to an event. Depending on the equipment type, the format and duration of data that is available may vary. From the perspective of assessing a core's condition, data that is closer to the end-of-use stage may be more relevant than data from earlier stages. Sensor/IoT data may be available to asset owners and operators as it pertains to use phase of the asset's lifecycle. In addition, OEMs and manufacturers of equipment may have access to the data, while dealers, service providers, and system integrators may only have periodic access.

The objective of acquiring sensor/IoT data is to provide value-added services like predictive maintenance in mostly early to mid-lifecycle stages of equipment use. However, during the late-lifecycle stages of aging equipment, such data can provide deeper insights into the condition of the equipment and its constituent components. Sensor/IoT data may be tracked between actual use and up to decommissioning of the asset.

While the earlier two types of data relate to the use phase of the equipment, tests and measurements data is typically collected after an asset/equipment has been returned as a core. However, in some cases, tests and measurements may also be performed while the product is within the control of an asset owner or operator. Tests and measurements data may include observations of, or measurements performed by, human inspector. The tests and measurements data may also include tests that are performed using a test equipment, fixture, or a rig. For instance, an electronic equipment, components, or parts, such as ECUs (electronic control units), may be plugged into a specific testing unit to extract data about the equipment. Such tests and measurements may be performed manually or by an automated testing system. The tests and measurements data is generated from at least one of remanufacturing provider, core broker, or dealer.

In addition to the three categories above, historical data of past cores is needed to train failure prediction models. Such historical data may include, but not limited to, past operational data, past sensor/IoT data, past tests and measurements data, ground truth data (i.e., real condition data about the cores) on faults that were observed, parts and processes that were needed to remanufacture the past cores, etc. Real condition of a core is only known when it is disassembled, cleaned, and inspected. Therefore, such data would typically be associated with cores that have been remanufactured by the remanufacturer in the past. The data may be available in records such as teardown records and remediation/remanufacturing records.

Referring back to FIG. 3, the acquired data is analyzed to predict potential faults associated with the selected core at S308. Approaches to data analyzation for fault prediction include, but not limited to, machine learning, deep learning, statistical analysis-based approaches, etc. Appropriate set of analytical approaches can be identified based on type, fidelity, volume, and accuracy of predictions associated with the data.

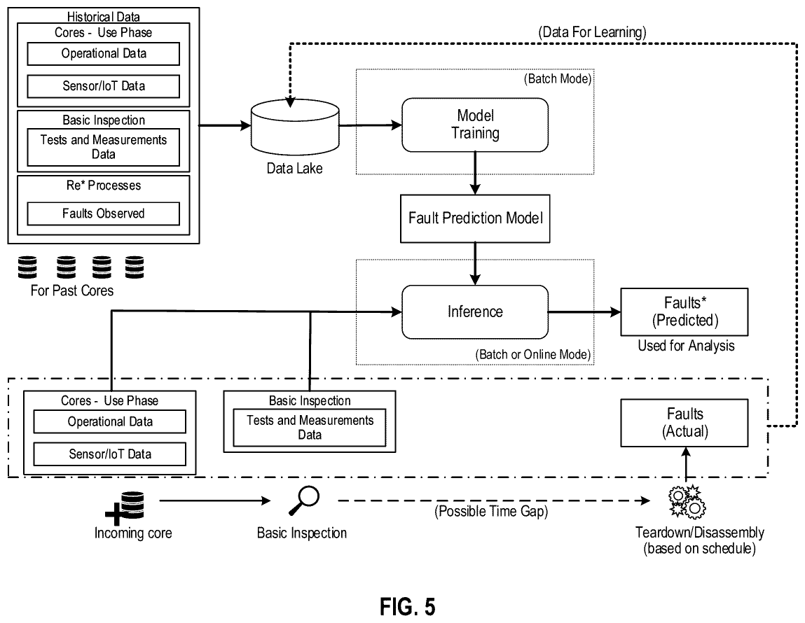

FIG. 5 illustrates an example flow process for building a machine learning model, in accordance with an example implementation. There are two key components to the machine learning model: model training and inferencing.

During the model training phase, historical data of past cores is used to train the model. The objective of model training is to build a mathematical model for detecting failures based on input data. Historical data may include data about a core, such as operational data, sensor/IoT data, and tests and measurements data, and actual faults observed that are discovered after disassembly, cleaning and inspection of the cores. The historical data may be stored at a data lake and then retrieved for processing and model training. Such data for cores remanufactured in the past is needed to train the model. The training process can happen under batch mode (e.g., periodically, such as based on time or after a certain number of cores have been processed). The model training process is described below.

Let P be the specific product/equipment (a SKU or model) under consideration whose cores are being evaluated. Let faults be the set of all the faults that can occur for P. Let A be the set of cores of product P for which historical data is available.

Then given:
xiotⁱ: Sensor/IoT data for core i where i∈A
xopsⁱ: Operational data for core i where i∈A
xtestsⁱ: Tests and measurements data for core i where i∈A
faultsⁱ: Set of faults that were observed in core i when it was disassembled, cleaned, and inspected, where i∈A and faultsⁱ ⊆faults

A model is then trained for faults observed in cores as a function of Sensor/IoT Data, Operational Data and Tests and Measurements Data.

$${faults}^{i} = {f}_{faults} ( {xiot}^{i} , {xops}^{i} , {xtests}^{i} )$$

The training phase generates a fault prediction model that models f_{faults}.

A model for fault prediction is generated by learning from historical data during the training phase. This model is then used, during an inference phase, to forecast faults for new/incoming cores. When a previously unanalyzed core comes in, it is subjected to a basic inspection where tests and measurements data is generated. The data along with the use phase data (i.e., operational data and sensor/IoT data) then run through the fault prediction model to generate predictions of faults. The inference operation can operate under batch mode (where a set of cores are analyzed) or online mode (where each core is analyzed live). The choice may depend on many factors, such as how long the inference takes or the specific business needs.

For evaluation of a core m (e.g., a new incoming core), based on its sensor/IoT data, xiot^{m}; operational data, xops^{m}; and tests and measurements data, xtests^{m}), and using the failure prediction model f_{faults}, the faults can be predicted as:

$${faults}^{m} = {f}_{faults} ( {xiot}^{m} , {xops}^{m} , {xtests}^{m} )$$

In some example implementations, an equipment may include multiple sensors. Data from such sensors will need to be analyzed in conjunction to generate complete assessment and faults prediction. Multiple sensors may provide a complementary view of the equipment (such as different subsystems), or they may provide a competing view (such as data redundant sensors), or they may provide a cooperating view to provide complete coverage. In some example implementations, subsets of sensors can have separate models and a meta-model can be trained to combine the faults estimated. In some example implementations, if sensors are looking at mutually exclusive systems, simple aggregation of faults from two subsystems may be possible. Based on the equipment, sensor fusion approaches may need to be considered to define model architecture and generate fault prediction models.

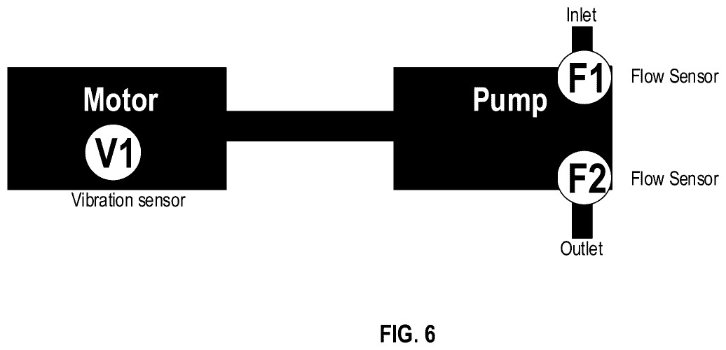

FIG. 6 illustrates an example pump driven by a motor, in accordance with an example implementation. As illustrates in FIG. 6, two flow sensors F1 and F2 exist on the inlet and outlet of the pump, and a vibration sensor V1 is located on the motor. Sensors F1 and F2 provide data on the state of the pump, and sensor V1 provides data on the state of the motor. In some example implementations, separate models for motor and pump are built for detecting the faults in the respective subsystems and then combining the results.

The two models are:
f_{faults}_{ₚᵤₘₚ}: models the faults of the pump
f_{faults}_{ₘₒₜₒᵣ}: models the faults of the motor

For core i, of type pump:

$${faults}_{pump}^{i} = {f}_{{faults}_{pump}} ( ( {xiot}_{F 1}^{i} , {xiot}_{F 2}^{i} ) , {xops}^{i} , {xtests}^{i} )$$

$${faults}_{motor}^{i} = {f}_{{faults}_{motor}} ( {xiot}_{V 1}^{i} , {xops}^{i} , {xtests}^{i} )$$

$$and ,$$

$${faults}^{i} = {faults}_{pump}^{i} {Ufaults}_{motor}^{i}$$

Referring back to FIG. 3, remanufacturing needs, such as part and processes required, are estimated at S310. During remanufacturing of a core there are parts that are always replaced, and there are parts that are replaced based on the condition (or fault). Similarly, as part of remanufacturing there are processes that are always performed (e.g., disassembly), and processes that are performed based on condition of the core (i.e., faults present in it).

There is a finite set of faults that can occur in a core (of a particular equipment). A core may have a number of faults arising out of actual use. Remanufacturing would entail fixing all identifiable faults associated with a core. Each fault may require zero or more parts and zero or more processes to fix for remanufacturing. The set of parts needed to fix a fault would be a subset of the BOM (bill of materials) of that equipment. BOM for remanufacturing an equipment core may include additional parts not included in the original product due to upcycling. This allows for upgrading the equipment, for instance with new sensors or parts that add new functionality not previously presented in the original product. BOM may also include changed, upgraded, or newer versions of parts compared to original. This may happen, for instance when design changes are applied to parts.

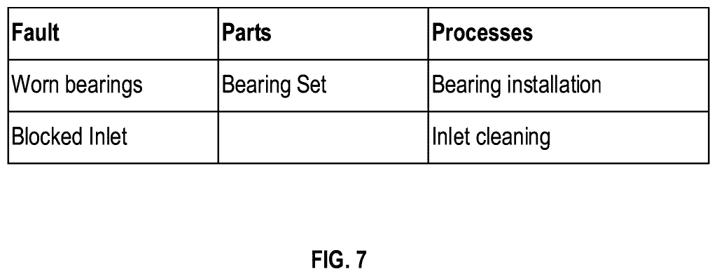

Different faults may have overlapping parts and process needs. The parts and processes needed to fix every possible fault for the equipment can be represented by a standard operating procedure (SOP). Such an SOP can be rule-based (e.g., derived based on a service manual). In some example implementations, the SOP can be a learned model generated by analyzing past remanufacturing data. FIG. 7 illustrates an example SOP table generated using analyzed past remanufacturing data, in accordance with an example implementation. Such an SOP can be modeled as a function that, given a fault in a core, returns the set of parts and processes needed to fix it. Then, given a core with a set of faults, the model of SOP can be used to derive the set of parts and processes needed to remediate a core. The SOP table may involve information such as, but not limited to, faults, parts, processes, etc. For example, for the fault “worn bearings”, the parts needed to remediate the core is “bearing set” and the process needed to for remediation is “bearing installation”.

Let faults be the set of faults that can occur for product P. Let parts be the set of parts included on the remanufacturing BOM for P. Let processes be the set of all the processes needed to remediate product P. Let partsⱼ be set of replacement parts needed to fix a fault faultⱼ; and processesⱼ be the set of processes to fix faultⱼ., with partsⱼ⊆parts and processesⱼ⊆processes and faultsⱼ∈faults.

For each fault of faultⱼ∈faults, there is a SOP (standard operating procedure) that defines what parts and processes are needed to fix the specific fault. Then SOP for the product can be modeled as functions:

$${parts}_{j} = {f}_{{sop}_{parts}} ( {fault}_{j} )$$

$${processes}_{j} = {f}_{{sop}_{process}} ( {fault}_{j} )$$

Let parts_{fixed} be the set of parts that are always replaced, and processes_{fixed} be the set of processes that are always executed when remanufacturing a core. For an incoming core i, with set of faults faultsⁱ we can derive the set of remediation needs as follows:

$${parts}_{i} = {parts}_{fixed} ⋃ ( {⋃}_{x ∈ {faults}^{i}} {f}_{{sop}_{parts}} ( x ) )$$

$${processes}_{i} = {processes}_{fixed} ⋃ ( {⋃}_{x ∈ {faults}^{i}} {f}_{{sop}_{process}} ( x ) )$$

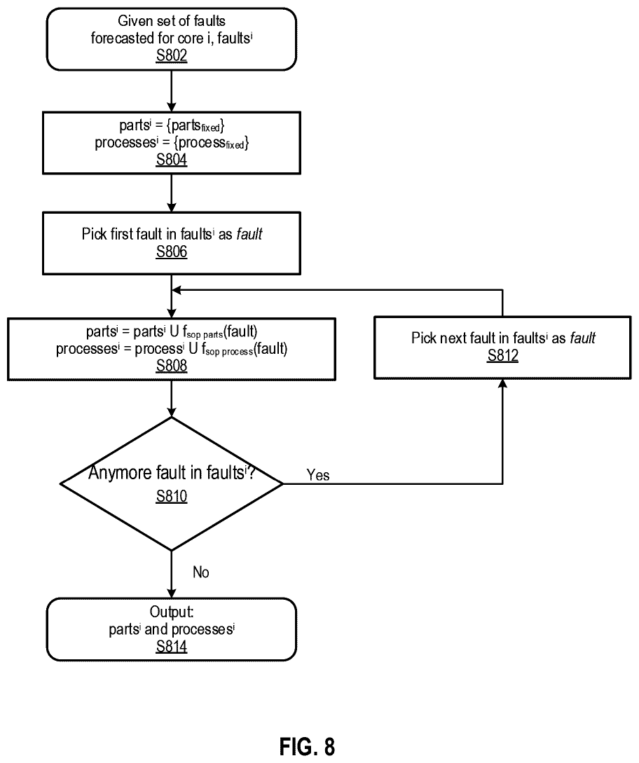

FIG. 8 illustrates an example process flow to derive remediation needs to remanufacture a core, in accordance with an example implementation. At S802, a set of faults, faultsⁱ, are forecasted for core i. At S804, setting partsⁱ to parts_{fixed} and processessⁱ to processes_{fixed}.

At S806, a first fault from faultsⁱ is selected as fault. At S808, setting

$${parts}^{i} = {parts}^{i} U {f}_{{sop}_{parts}} ( fault )$$

$${processess}^{i} = {processes}^{i} U {f}_{{sop}_{process}} ( fault )$$

At S810, it is determined whether there is any fault left to be addressed. If the answer is yes at S810, then the process proceeds to S812, where the next fault in faults is selected as fault and the process returns to S808 for further processing. If the answer is no at S810, then the process proceeds to S814. At S814, the set of parts and processes that are estimated to require fixing for a core i are outputted.

Referring back to FIG. 3, economic and environment impact/footprint associated with the core's remanufacturing are estimated at S312. Specifically, metrics for part and processes needed to remanufacture the core. The metrics include, but not limited to, cost, energy, emissions, water usage, etc. associated with at least one of environmental value or economic value. Each part that is replaced and each process that is executed to remanufacture a core has both an economic and environmental impact.

When a part is manufactured, depending upon its composition, a certain amount of energy is expended to bring constituent materials to a state where the materials become usable for the part. Similarly, emissions are also associated with this process of transforming materials. It can be assumed that the energy and emissions are embedded in the part. In some example implementations, other processing factors may include, but not limited to, water usage, effluents, volatile organic compounds (VOCs), etc. As part of remanufacturing, if a part cannot be reused and must be replaced with a new part, then energy and emissions embedded in the part will have to be expended again. In economic terms, a cost is also associated with the new part.

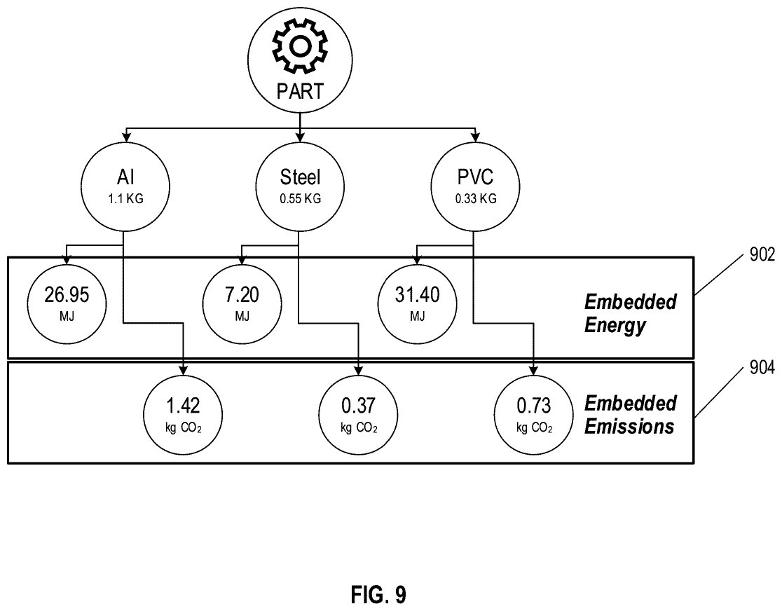

To derive the emissions and energy embedded in a part, an assessment of its constituents and manufacturing process can be performed through approximation. An approximation is to look at constituent materials of the part and then use standardized tables to derive the baseline embedded emissions and energy. FIG. 9 illustrates an example computation process of embedded energy and emissions, in accordance with an example implementation.

The embedded energy is a quantified resource required to produce part and perform associated processes, and the embedded emissions (environmental cost) is an amount of environmental cost generated by producing the part and performing the processes. The embedded energy includes, but not limited to, at least one of energy consumption, water usage, material usage, etc. The embedded emissions include, but not limited to, at least one of greenhouse gas emissions, effluents hazardous to aquatic environment, volatile organic compounds (VOCs), or landfill waste.

If a part partₖ is composed of m different materials, and if material i, which has embedded energy Ematᵢ, is in quantity Qi in the part, with i∈{1, 2, . . . m}, and Emanfₖ is the energy used in the manufacturing process of partₖ, then, total embedded energy in partₖ is:

$${Epart}_{k} = {\sum }_{1}^{m} {Emat}_{i} * {Q}_{i} + {Emanf}_{k}$$

Similarly, if embedded emissions of material i are GHGmatᵢ and process emissions associated with the manufacturing process of parts are GHGmanfₖ, then total embedded emissions in partₖ are:

$${GHGpart}_{k} = {\sum }_{1}^{m} {GHGmat}_{i} * Qi + {GHGmanf}_{k}$$

As with the parts, each process of remediation will consume a certain amount of energy and result in a certain quantity of emissions. Each process will also have an associated cost. These can be derived by measuring emissions, energy, and costs associated with the process over time and averaging over the units that passed through the process during that time. Apart from emissions and energy, other factors such as, but not limited to, water usage, volatile organic compounds (VOCs), etc. can be tracked as well.

Let Epartₖ be the energy embedded in partₖ (as derived earlier); GHGpartₖ be the emissions embedded in partₖ; and Cpartₖ be the cost of parts, where partₖ∈Parts i.e., the set of parts that can be replaced on product P.

Let Eprocessₚ be the energy usage of processₚ; GHGprocessₚ be the emissions associated with processₚ; and Cprocessₚ be the costs associated with processₚ, where processₚ∈Processes i.e., the set of all the processes for fixing P.

Let C_{fixed} be the fixed costs of remanufacturing a core that are not associated with parts and processes.

Then, as derived in the previous step, if partsⁱ is the set of parts, processesⁱ is the set of processes, and costs are costs needed to remanufacture core i, then:

Energy embedded to remanufacture core i:

$${Energy}^{i} = {\sum }_{k ∈ {Parts}^{i}} {Epart}_{k} + {\sum }_{p ∈ {Process}^{i}} {Eprocess}_{p}$$

Emissions embedded to remanufacture core i:

$${Emissions}^{i} = {\sum }_{k ∈ {Parts}^{i}} {GHGpart}_{k} + {\sum }_{p ∈ {Process}^{i}} {GHGProcess}_{p}$$

Costs to remain core i:

$${Costs}^{i} = {\sum }_{k ∈ {Parts}^{i}} {Cpart}_{k} + {\sum }_{p ∈ {Process}^{i}} {CProcess}_{p} + {C}_{fixed}$$

The outputs of S312 for a core i, with predicted set of faults (faultsⁱ), and the set of parts (partsⁱ) and processes (processesⁱ) that are estimated to be needed to fix the set of faults, are estimates of energy needed to remanufacture the core (energyⁱ), emissions associated with remanufacture of the core (emissionsⁱ), and costs associated with remanufacturing the core (costsⁱ). These can be applied directly in making the remanufacturing decision about a core, can be fed to decision support framework, or can be combined to derive a utility measure as outlined in the next step.

Referring back to FIG. 3, utility for the core is generated for the selected core at S314. Utility of remanufacturing a core is a measure that factors in a number of dimensions (e.g., energy, emissions, and costs) and allows comparison of utilities between different cores. The utility measure represents an estimate of potential value generated or potential impact generated if a core is remanufactured. The potential value measures a first estimate of economic value associated with remanufacturing of a core and the potential impact measures a second estimate of environmental and/or economic impact associated with remanufacturing of a core.

For a core i, based on the estimated energy needed to remanufacture the core (Energyⁱ), estimated emissions associated with remanufacturing of the core (Emissionsⁱ), and estimated costs associated with remanufacturing the core (Costsⁱ), the utility measure Uⁱ is defined as:

$${U}^{i} = agg ( {Energy}^{i} , {Emissions}^{i} , {Costs}^{i} )$$

Uⁱ is an aggregate utility function computed using an aggregation function agg. agg can have many forms and is dependent on various factors such as, but not limited to, business, type of equipment, end-user context, etc. Examples of agg include but are not limited to:
i. weighted aggregate: Uⁱ=w_{energy}Energyⁱ+wₑₘᵢₛₛᵢₒₙₛEmissionsⁱ+w_{costs}Costsⁱ, where w_{energy}, wₑₘᵢₛₛᵢₒₙₛ, w_{costs} are weights stated by end-user or computed using historical data; and
ii. KPI conversion: Uⁱ=Energyⁱ_{cost}+Emissionsⁱ_{cost}+Costsⁱ_{cost}, where each utility component is converted to a cost equivalent. In some example implementations, other formulations may be used and include conversion to a different unit.

In some example implementations, U′ is derived by first assigning weight values to the costs, the embedded energy, and the embedded emissions. Then the costs, the embedded energy, and the embedded emissions are multiplied with their respective weight value to generate product values. The generated product values are then summed to produce a summed product value. A product fraction is generated by dividing the summed product value against a reference value to generate a product fraction. The Uⁱ is then obtained by subtracting the product fraction from a value of one.

Referring back to FIG. 3, the measured utility for the selected core is added to the list at S316. At S318, it is determined whether there is any core on the list for which utility is not available. If the answer is yes at S318, then the process returns to S304 for core selection. If the answer is no at S318, then the list is sorted based on measured utility to get the prioritized list of cores for Re* at S320.

To put it all together, the above approach can be used to select a core for production from a set of cores. The first step will be to compute the utilities for the cores in the set (by executing steps S306-S314 above). Then the list of cores in the set can be ordered based on utilities to derive a prioritized list.

Given an inventory of cores, B, which needs to be prioritized, the next core to remanufacture can be identified by:

$${argmax}_{i ∈ B} {U}^{i}$$

The process as illustrated in FIG. 3 may also be utilized upstream to the core procurement phase for core pricing and core buying decision making. The same process may also be utilized further upstream to the asset operations phase for providing asset decommissioning decision support.

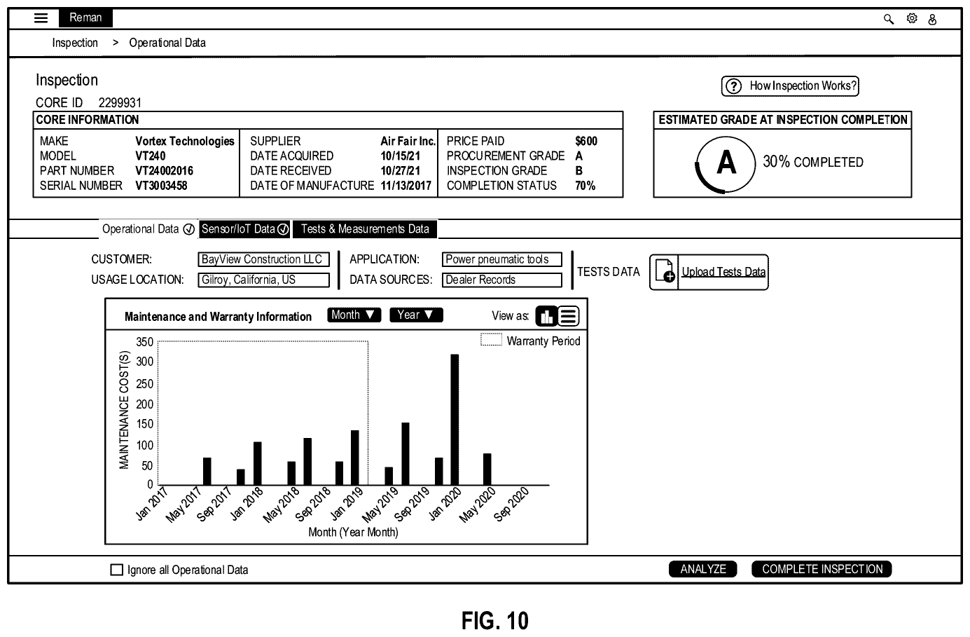

FIG. 10 illustrates an example display for viewing, uploading, and analyzing the operational data using the core condition assessment and validation process, in accordance with an example implementation. As illustrated in FIG. 10, a graphic user interface (GUI) may be used for data processing in association with the three categories of data. The GUI and system allow sharing of data between value-chain stakeholders. Operational data can be retrieved directly from the underlying system based on the equipment's identifying information and displayed on the GUI. In some example implementations, the user (e.g., a core inspector) may manually upload available operational data for a core. As illustrated in FIG. 10, information displayed on the GUI may include graphic representations of captured operational data, manufacturing information pertaining to the selected core, acquisition information pertaining to the selected core, pricing information pertaining to the selected core, and status information pertaining to the selected core.

The user can choose to analyze just the operational data and get a partial estimate of a core grade or wait for all the data to be uploaded before initiating the analysis. Based on thresholds of utility measure, core grades can be assigned to the cores (e.g., A, B, C, etc.) The grades allow cores to be quickly classified and prioritized.

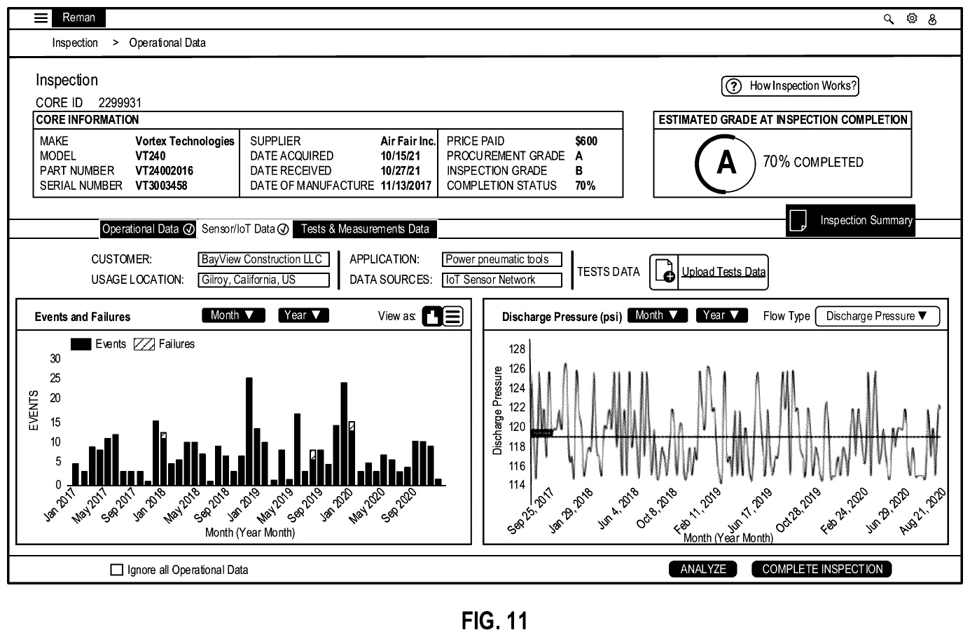

FIG. 11 illustrates an example screen for viewing, uploading, and analyzing the sensor/IoT data using the core condition assessment and validation process, in accordance with an example implementation. As illustrated in FIG. 11, information displayed on the GUI may include graphic representations of captured sensor/IoT data. In some example implementations, the captured sensor/IoT data may be displayed graphically in time-series. Sensor/IoT data can be retrieved directly from the underlying system based on the equipment's identifying information and displayed on the GUI. In some example implementations, the user (e.g., a core inspector) may manually upload available sensor/IoT data for a core. The user can choose to analyze just the sensor/IoT data and get a partial estimate of the core grade or wait for all the data to be uploaded before initiating the analysis.

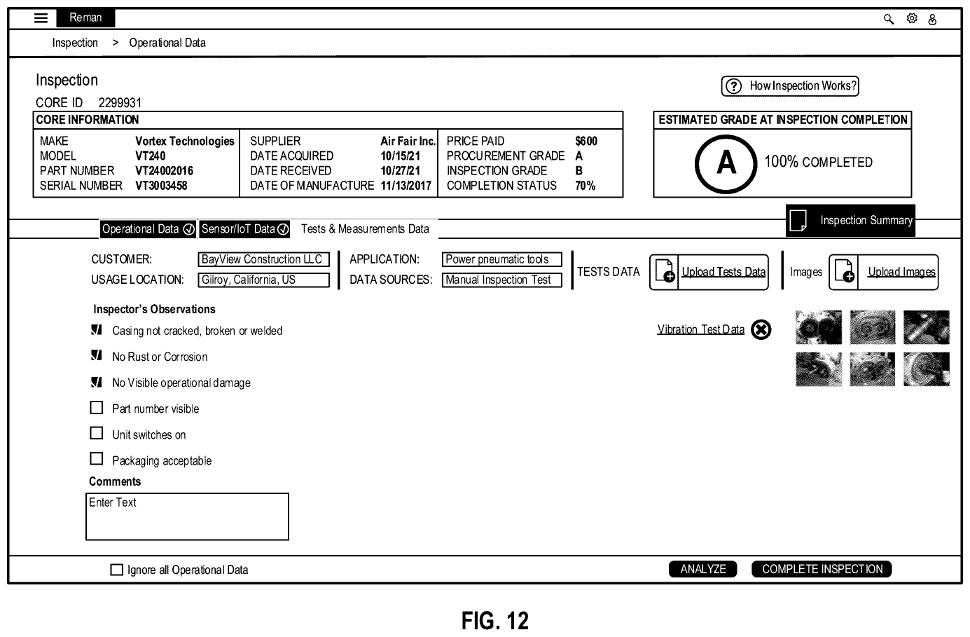

FIG. 12 illustrates an example screen for viewing, uploading, and analyzing the tests and measurements data using the core condition assessment and validation process, in accordance with an example implementation. As illustrated in FIG. 12, information displayed on the GUI may include an observation report from an inspector. Data may be uploaded directly from a testing equipment used by the remanufacturer to examine a core. In addition, image data for critical components may be added for automated analysis and displayed. The user can choose to analyze just the test and measurements data and get a partial estimate of the core grade or wait for all the data to be uploaded before initiating the analysis.

Once the operational data, sensor/IoT data, and tests and measurements data are uploaded, the user can analyze the data and complete inspection, which in turn generates predictions, computes the final core grade, and creates an inspection summary.

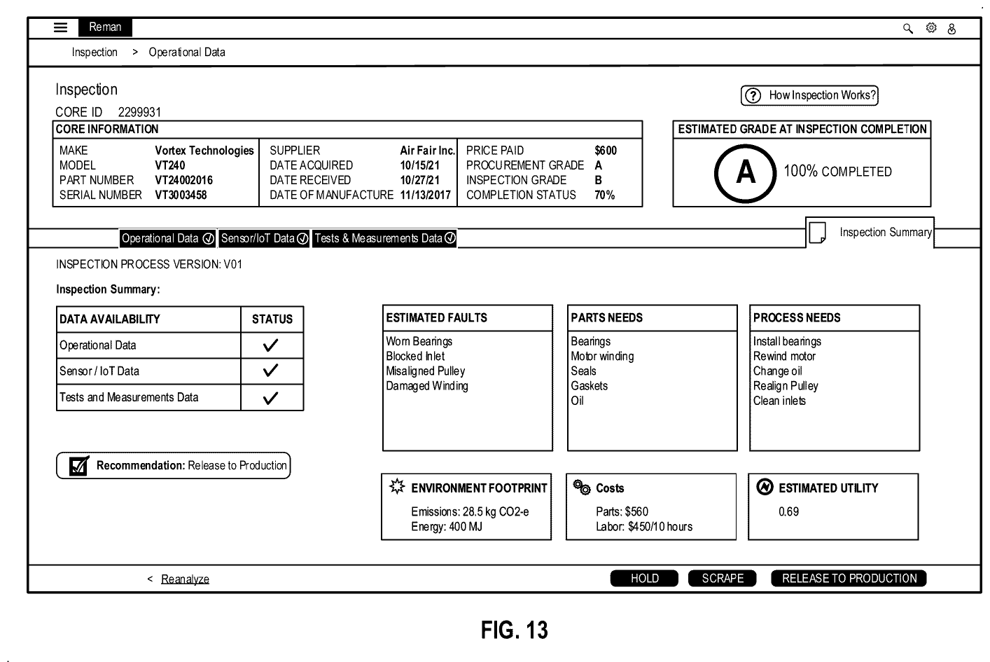

FIG. 13 illustrated an example inspection summary page, in accordance with an example implementation. Upon analyzing the three data categories, an inspection summary (i.e., a core health card) is produced. Inspection summary may show the types of data analyzed to generate predictions. It shows a list of possible faults forecasted to be in the core, and estimates of parts and processes that are needed to remanufacture the core. In addition, the inspection summary shows the estimates of associated environmental footprint (in terms of energy usage and emissions) and costs. The inspection summary may also show the utility measure (which is also translated into a core grade), which can be used to compare and prioritize cores. The inspection summary may also provide decision support to the user by recommending action to be taken for the core. The user can accept the recommendation or make independent judgment on an action for the core.

The foregoing example implementation may have various benefits and advantages. For example, core prioritization is achieved on the remanufacturing end through the data-driven approach to a priori core condition assessment. Both environmental and economic impact may be considered in assessing a core's utility measure. In addition, provision of value and impact assessment allow a remanufacturer to determine economic and environment impact/footprint associated with the core's remanufacturing and whether such values align with their production objectives.

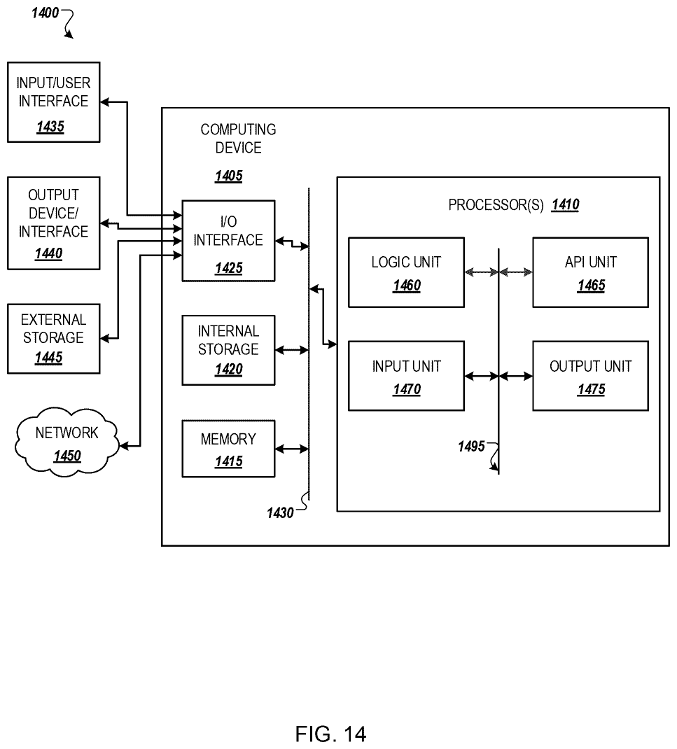

FIG. 14 illustrates an example computing environment with an example computer device suitable for use in some example implementations. Computer device 1405 in computing environment 1400 can include one or more processing units, cores, or processor(s) 1410, memory 1415 (e.g., RAM, ROM, and/or the like), internal storage 1420 (e.g., magnetic, optical, solid-state storage, and/or organic), and/or IO interface 1425, any of which can be coupled on a communication mechanism or bus 1430 for communicating information or embedded in the computer device 1405. IO interface 1425 is also configured to receive images from cameras or provide images to projectors or displays, depending on the desired implementation.

Computer device 1405 can be communicatively coupled to input/user interface 1435 and output device/interface 1440. Either one or both of the input/user interface 1435 and output device/interface 1440 can be a wired or wireless interface and can be detachable. Input/user interface 1435 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1440 may include a display, television, monitor, printer, speaker, braille, or the like. In some example implementations, input/user interface 1435 and output device/interface 1440 can be embedded with or physically coupled to the computer device 1405. In other example implementations, other computer devices may function as or provide the functions of input/user interface 1435 and output device/interface 1440 for a computer device 1405.

Examples of computer device 1405 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1405 can be communicatively coupled (e.g., via IO interface 1425) to external storage 1445 and network 1450 for communicating with any number of networked components, devices, and systems, including one or more computer devices of the same or different configuration. Computer device 1405 or any connected computer device can be functioning as, providing services of, or referred to as a server, client, thin server, general machine, special-purpose machine, or another label.

IO interface 1425 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 1400. Network 1450 can be any network or combination of networks (e.g., the Internet, local area network, wide area network, a telephonic network, a cellular network, satellite network, and the like).

Computer device 1405 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1405 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1410 can execute under any operating system (OS) (not shown), in a native or virtual environment. One or more applications can be deployed that include logic unit 1460, application programming interface (API) unit 1465, input unit 1470, output unit 1475, and inter-unit communication mechanism 1495 for the different units to communicate with each other, with the OS, and with other applications (not shown). The described units and elements can be varied in design, function, configuration, or implementation and are not limited to the descriptions provided. Processor(s) 1410 can be in the form of hardware processors such as central processing units (CPUs) or in a combination of hardware and software units.

In some example implementations, when information or an execution instruction is received by API unit 1465, it may be communicated to one or more other units (e.g., logic unit 1460, input unit 1470, output unit 1475). In some instances, logic unit 1460 may be configured to control the information flow among the units and direct the services provided by API unit 1465, the input unit 1470, the output unit 1475, in some example implementations described above. For example, the flow of one or more processes or implementations may be controlled by logic unit 1460 alone or in conjunction with API unit 1465. The input unit 1470 may be configured to obtain input for the calculations described in the example implementations, and the output unit 1475 may be configured to provide an output based on the calculations described in example implementations.

Processor(s) 1410 can be configured to acquire available core data for a selected core from a plurality of cores as shown in FIG. 3. The processor(s) 1410 may also be configured to analyze the available core data related to the selected core to assess an internal condition of the selected core and identify faults as shown in FIG. 3. The processor(s) 1410 may also be configured to identify, based on the internal condition and the identified faults, part and processes needed to remanufacture the core as shown in FIG. 3. The processor(s) 1410 may also be configured to derive metrics for part and processes needed to remanufacture the core as shown in FIG. 3. The processor(s) 1410 may also be configured to compute, from the derived metrics, a utility measure representing an estimate of potential value generated or potential impact generated if the core is remanufactured as shown in FIG. 3. The processor(s) 1410 may also be configured to determine a remanufacturing priority based on the computed utility measure as shown in FIG. 3. The processor(s) 1410 may also be configured to perform remanufacturing of the selected core based on the determined remanufacturing priority as shown in FIG. 3.

The processor(s) 1410 may also be configured to compute utility measure for the plurality of cores as shown in FIG. 3. The processor(s) 1410 may also be configured to add the computed utility measure for the plurality of cores to a remanufacturing priority list as shown in FIG. 3. The processor(s) 1410 may also be configured to sort the remanufacturing priority list according to the computed utility measure for the plurality of cores as shown in FIG. 3. The processor(s) 1410 may also be configured to process the plurality of cores based on the sorted remanufacturing priority list as shown in FIG. 3.

The processor(s) 1410 may also be configured to display the available core data, the utility measure, and the remanufacturing priority through a Graphic user interface (GUI), wherein the GUI generates at least one of a time-series graphic representation and a textual result display based the available core data, faults and remediation needs, the utility measure, or the remanufacturing priority as shown in FIG. 11.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to, optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for core remanufacturing evaluation, the method comprising:
acquiring available core data for a selected core from a plurality of cores;
analyzing the available core data related to the selected core to assess an internal condition of the selected core and identify faults;
identifying, based on the internal condition and the identified faults, part and processes needed to remanufacture the core;
deriving metrics for part and processes needed to remanufacture the core;
computing, from the derived metrics, a utility measure representing an estimate of potential value generated or potential impact generated if the core is remanufactured;
determining a remanufacturing priority based on the computed utility measure; and
performing remanufacturing of the selected core based on the determined remanufacturing priority.

2. The method of claim 1, wherein the available core data comprises operational data, sensor or internet of things (IOT) data, and tests and measurements data related to the selected core.

3. The method of claim 2, wherein the operational data and the sensor or IoT data are acquired from at least one of asset operator, original equipment manufacturer, dealer, or maintenance service provider; and wherein the tests and measurements data is generated from at least one of remanufacturing provider, core broker, or dealer.

4. The method of claim 1,
wherein the potential value measures a first estimate of economic value associated with remanufacturing of a core; and
wherein the potential impact measures a second estimate of environmental and/or economic impact associated with remanufacturing of a core.

5. The method of claim 1, wherein the metrics comprise at least one of cost, energy, emissions, or water usage associated with at least one of environmental value or economic value.

6. The method of claim 1, further comprising:
computing utility measure for the plurality of cores;
adding the computed utility measure for the plurality of cores to a remanufacturing priority list sorting the remanufacturing priority list according to the computed utility measure for the plurality of cores; and
processing the plurality of cores based on the sorted remanufacturing priority list.

7. The method of claim 1, wherein fault identification comprises:
using the available core data as input to a fault analyzing model to estimate fault, wherein the fault analyzing model is generated by analyzing historical data using any or combination of machine learning (ML), deep learning, and statistical analysis-based approaches.

8. The method of claim 1, wherein the deriving metrics for part and processes needed to remanufacture the core comprises:
identifying the part and the processes needed to remanufacture the core based on the identified faults;
estimating components cost associated with the identified part and labor cost associated with the identified processes;
estimating embedded factor and embedded environmental cost associated with the identified part and the identified processes, where the embedded factor is a quantified resource required to produce the identified part and perform the identified processes, and the embedded environmental cost is an amount of environmental cost generated by producing the identified part and performing the identified processes; and
outputting the component cost, the labor cost, the embedded factor, and the embedded environmental cost as the derived metrics,
wherein the embedded factor comprises at least one of energy consumption, water usage, or material usage, and the embedded environmental cost comprises at least one of greenhouse gas emissions, effluents hazardous to aquatic environment, volatile organic compounds (VOCs), or landfill waste.

9. The method of claim 8, the computing the utility measure comprises:
grouping component cost and labor cost as total cost;
assigning weight values to the total cost, the embedded first factor, and the embedded second factor, respectively;
multiplying the total cost, the embedded first factor, and the embedded second factor with their respective weight value to generate product values;
summing the product values to generate product sum;
dividing the product sum with a reference value to generate product fraction; and
subtracting the product fraction from a value of one to produce the utility measure.

10. The method of claim 1, further comprising displaying the available core data, the utility measure, and the remanufacturing priority through a Graphic user interface (GUI), wherein the GUI generates at least one of a time-series graphic representation and a textual result display based on the available core data, faults and remediation needs, the utility measure, or the remanufacturing priority.

11. A non-transitory computer readable medium, storing instructions for core remanufacturing evaluation, the instructions comprising:
acquiring available core data for a selected core from a plurality of cores;
analyzing the available core data related to the selected core to assess an internal condition of the selected core and identify faults;
identifying, based on the internal condition and the identified faults, part and processes needed to remanufacture the core;
deriving metrics for part and processes needed to remanufacture the core;
computing, from the derived metrics, a utility measure representing an estimate of potential value generated or potential impact generated if the core is remanufactured;
determining a remanufacturing priority based on the computed utility measure; and
performing remanufacturing of the selected core based on the determined remanufacturing priority.

12. The non-transitory computer readable medium of claim 11, wherein the available core data comprises operational data, sensor or internet of things (IOT) data, and tests and measurements data related to the selected core.

13. The non-transitory computer readable medium of claim 12, wherein the operational data and the sensor or IoT data are acquired from at least one of asset operator, original equipment manufacturer, dealer, or maintenance service provider; and wherein the tests and measurements data is generated from at least one of remanufacturing provider, core broker, or dealer.

14. The non-transitory computer readable medium of claim 11,
wherein the potential value measures a first estimate of economic value associated with remanufacturing of a core; and
wherein the potential impact measures a second estimate of environmental and/or economic impact associated with remanufacturing of a core.

15. The non-transitory computer readable medium of claim 11, wherein the metrics comprise at least one of cost, energy, emissions, or water usage associated with at least one of environmental value or economic value.

16. The non-transitory computer readable medium of claim 11, further comprising:
computing utility measure for the plurality of cores;
adding the computed utility measure for the plurality of cores to a remanufacturing priority list;
sorting the remanufacturing priority list according to the computed utility measure for the plurality of cores; and
processing the plurality of cores based on the sorted remanufacturing priority list.

17. The non-transitory computer readable medium of claim 11, wherein fault identification comprises:
using the available core data as input to a fault analyzing model to estimate fault, wherein the fault analyzing model is generated by analyzing historical data using any combination of machine learning (ML), deep learning, and statistical analysis-based approaches.

18. The non-transitory computer readable medium of claim 11, wherein the deriving metrics for part and processes needed to remanufacture the core comprises:
identifying the part and the processes needed to remanufacture the core based on the identified faults;
estimating components cost associated with the identified part and labor cost associated with the identified processes;
estimating embedded factor and embedded environmental cost associated with the identified part and the identified processes, where the embedded factor is a quantified resource required to produce the identified part and perform the identified processes, and the embedded environmental cost is an amount of environmental cost generated by producing the identified part and performing the identified processes; and
outputting the component cost, the labor cost, the embedded factor, and the embedded environmental cost as the derived metrics,
wherein the embedded factor comprises at least one of energy consumption, water usage, or material usage, and the embedded environmental cost comprises at least one of greenhouse gas emissions, effluents hazardous to aquatic environment, volatile organic compounds (VOCs), or landfill waste.

19. The non-transitory computer readable medium of claim 18, the computing the utility measure comprises:
grouping component cost and labor cost as total cost;
assigning weight values to the total cost, the embedded first factor, and the embedded second factor, respectively;
multiplying the total cost, the embedded first factor, and the embedded second factor with their respective weight value to generate product values;
summing the product values to generate product sum;
dividing the product sum with a reference value to generate product fraction; and
subtracting the product fraction from a value of one to produce the utility measure.

20. The non-transitory computer readable medium of claim 11, further comprising displaying the available core data, the utility measure, and the remanufacturing priority through a Graphic user interface (GUI), wherein the GUI generates at least one of a time-series graphic representation and a textual result display based the available core data, faults and remediation needs, the utility measure, or the remanufacturing priority.
